(19) United States
(12) Patent Application Publication
(10) Pub. No.: US 2024/0320861 A1
(43) Pub. Date: Sep. 26, 2024

(54) MARKER BASED OPTICAL 3D TRACKING SYSTEM CALIBRATION

(71) Applicants: Smith & Nephew, Inc., Memphis, TN (US); Smith & Nephew Asia Pacific Pte. Limited, SG (SG); Smith & Nephew Orthopaedics AG, Zug (CH)

(72) Inventors: Stéphane TOURNEUR, Corseaux (CH); Sylvain BERNHARDT, Lugrin (FR); Olivier GIRARD, Gland (CH)

(21) Appl. No.: 18/614,884

(22) Filed: Mar. 25, 2024

Related U.S. Application Data
(60) Provisional application No. 63/454,461, filed on Mar. 24, 2023.

(51) Int. Cl. G06T 7/80

(52) U.S. Cl. CPC G06T 7/80; G06T 2207/30208

(57) ABSTRACT

Systems and methods for calibrating an optical tracking system, using a non-planar rigid artifact, are disclosed. Absolute calibration data comprising conditions for validity is determined based on the known geometry of the artifact. The optical tracking system is placed in the conditions for validity. A relative movement between the artifact and the optical sensor is produced across a working volume. Positional data is acquired for each of the plurality of fiducials using the optical sensor. An artifact geometry is determined based on the positional data and the absolute calibration data. The optical system is placed in a different condition. Relative movement is produced between the artifact and the optical sensor across the working volume. Raw positional data is acquired foreach of the plurality of fiducials using the optical sensor. Relative calibration parameters of the optical tracking system are determined based on the raw positional data and the artifact geometry.

### CROSS-REFERENCE TO RELATED APPLICATIONS

This application claims the benefit of priority to U.S. Provisional Application No. 63/454,461, entitled “Marker Based Optical 3D Tracking System Calibration,” filed Mar. 24, 2023, which is incorporated herein by reference in its entirety.

### TECHNICAL FIELD

The present disclosure relates generally to methods, systems, and apparatuses related to a computer-assisted surgical system that includes various hardware and software components that work together to enhance surgical workflows. The disclosed techniques and apparatuses may be applied to, for example, shoulder, hip, and knee arthroplasties, as well as other surgical interventions such as arthroscopic procedures, spinal procedures, maxillofacial procedures, neuro-surgery procedures, rotator cuff procedures, ligament repair and replacement procedures.

### BACKGROUND

Fiducial markers, also called fiducials or markers, are small reference points rigidly attached to objects to be tracked to facilitate the reconstruction of the object pose by an optical vision system. Marker based optical 3D tracking systems are used in many fields, such as Computer Assisted Surgery (CAS), Robotic Assisted Surgery (RAS), rehabilitation, industrial dimension quality control, 3D scanning and motion tracking. Markerless tracking systems also exist (e.g., Microsoft Kinect), but such systems rely on heavy image analysis algorithms and are less precise.

Manufacturers of optical tracking systems publish localization accuracy specifications, but such specifications are only accurate when the systems have been recently calibrated. Calibration is the process that enables the proper characterization of the optical parameters of the tracking system, like the relative pose of the cameras (i.e., camera extrinsic parameters), their focal distance, principal point, and optical aberrations (i.e., camera intrinsic parameters). Calibration must be performed for the tracking system to provide accurate localization data. Optical tracking systems may suffer from calibration drift over time due to, for example, the aging of materials composing their lenses, and/or vibrations and shocks. This amount of error is insignificant for most cameras but it is important for optical 3D tracking applications that require submillimeter positioning accuracy within a large working volume (i.e., the 3D space viewed by the optical system up to a certain distance). Thus, due to inevitable calibration drift over time, optical 3D tracking systems must be maintained regularly and recalibrated in order to retain their accuracy performance.

However, current camera calibration processes for fiducials-based optical tracking systems are often inaccurate, time-consuming, or cumbersome, thereby making frequent camera recalibrations impractical. Furthermore, many existing calibration processes specifically function only in the visible light spectrum. As optical 3D tracking systems that at least partially use infrared or near-infrared reflective fiducials are implemented more frequently, these existing calibration processes cannot be used.

Therefore, it would be beneficial to provide a camera calibration process for accuracy-demanding optical tracking systems based on the tracking of fiducials in the infrared or near-infrared wavelength, which is simultaneously fast, easy to perform, and accurate enough to render frequent camera recalibrations practical.

### SUMMARY

In embodiments, a device for calibrating an optical tracking system includes a pyramidal frame including two triangular supports, and a base element; and a plurality of markers, each including three or more retroreflective fiducials in a mutually exclusive geometry, wherein the plurality of markers are interfaced vertices of the pyramidal frame.

In some embodiments, the pyramidal frame further includes a plurality of distal supports, wherein each distal support interfaces the base element to a distal end of one of the two triangular supports.

In some embodiments, the base element is configured to be held by an operator.

In some embodiments, the base element is configured to be interfaced to a machine including at least one of: a robot arm, a spider crane robot, a cartesian robot, a drone, or a wire-driven manipulator.

In some embodiments, for a smallest circumscribed rectangular parallelepiped, a maximal dimension length of the device is less than four times a minimal dimension length of the device.

In some embodiments, the device occupies at least one twentieth of a calibration working volume as determined from a perspective of the optical tracking system.

In some embodiments, the frame is made from 090 carbon epoxy laminate.

In some embodiments, a method for providing a calibration for a marker-based optical tracking system includes providing a non-planar rigid artifact with a known geometry including a plurality of fiducials; providing an optical sensor to be calibrated; producing relative movement between the artifact and the optical sensor across a working volume; acquiring raw positional data of each of the plurality of fiducials, using the optical sensor; and determining calibration parameters of the optical tracking system based on the raw positional data and the artifact geometry.

In some embodiments, the method includes capturing current environmental conditions and associating them with the calibration parameters.

In some embodiments, the method includes measuring the artifact geometry with a coordinate measurement machine.

In some embodiments, the fiducials are retroreflective.

In some embodiments, the fiducials are LEDs.

In some embodiments, producing relative movement between the artifact and the optical sensor across a working volume includes moving the artifact.

In some embodiments, producing relative movement between the artifact and the optical sensor across a working volume includes moving the optical sensor.

In some embodiments, the environmental conditions include at least one of: an internal temperature of the optical sensor, an external temperature, an internal humidity of the optical sensor, an external humidity, an orientation, a gravitational vector, and a local acceleration vector of the optical sensor.

In some embodiments, producing relative movement between the artifact and the optical sensor across a working volume is performed by a machine including at least one of: a robot arm, a spider crane robot, a cartesian robot, a drone, or a wire-driven manipulator.

In some embodiments, a method for providing a relative calibration an optical tracking system includes providing a non-planar rigid artifact including a plurality of fiducials; providing an optical sensor to be calibrated; receiving absolute calibration data for the optical tracking system including conditions for validity; placing the optical tracking system in the conditions for validity; producing relative movement between the artifact and the optical sensor across a working volume; acquiring raw positional data of each of the plurality of fiducials, using the optical sensor; determining an artifact geometry based on the raw positional data and the absolute calibration data; placing the optical system in a different condition; producing relative movement between the artifact and the optical sensor across the working volume; acquiring raw positional data of each of the plurality of fiducials, using the optical sensor; and determining relative calibration parameters of the optical tracking system based on the raw positional data and the artifact geometry for the different condition.

In some embodiments, the fiducials are retroreflective.

In some embodiments, the fiducials are LEDs.

In some embodiments, producing relative movement between the artifact and the optical sensor across a working volume includes moving the artifact.

In some embodiments, producing relative movement between the artifact and the optical sensor across a working volume includes moving the optical sensor.

In some embodiments, the conditions for validity include at least one of: an internal temperature, an external temperature, an internal humidity, an external humidity, an orientation, a gravitational vector, and a local acceleration vector of the optical sensor.

In some embodiments, producing relative movement between the artifact and the optical sensor across a working volume is performed by a machine including at least one of: a robot arm, a spider crane robot, a cartesian robot, a drone, or a wire-driven manipulator.

### BRIEF DESCRIPTION OF THE DRAWINGS

The accompanying drawings, which are incorporated in and form a part of the specification, illustrate the embodiments of the invention and together with the written description serve to explain the principles, characteristics, and features of the invention. In the drawings:

FIG. 1 depicts an operating theatre including an illustrative computer-assisted surgical system (CASS) in accordance with an embodiment.

FIG. 2 depicts an illustrative Coordinate Measurement Machine in accordance with an embodiment.

FIG. 3A illustrates a process for moving a chessboard by an operator in front of the camera for calibration.

FIG. 3B illustrates an example chessboard pattern applied to non-planar (e.g., a cubic) calibration boards.

FIG. 3C depicts an illustrative non-planar artifact with eight colored balls mounted around a core.

FIG. 4 depicts an illustrative non-planar rigid artifact in accordance with an embodiment.

FIG. 5 illustrates an exploded view of the pyramidal artifact of FIG. 3.

FIG. 6 depicts an illustrative first triangular support in a front and side perspective in accordance with an embodiment.

FIG. 7 depicts an illustrative second triangular support in a front and side perspective in accordance with an embodiment.

FIG. 8 depicts an illustrative distal support in a front and side perspective in accordance with an embodiment.

FIG. 9 depicts an illustrative base element in a front, rotated, and side perspective in accordance with an embodiment.

FIG. 10 depicts an illustrative process for enabling the absolute calibration of an optical system in accordance with an embodiment.

FIG. 11 depicts an illustrative process for enabling the relative calibration of an optical system in accordance with an embodiment.

FIG. 12 depicts an illustrative graphical user interface for guiding an operator toward an optimal (e.g., fast and uniform) path inside the working volume as they produce relative movement between the artifact and the optical sensor in accordance with an embodiment.

FIG. 13 depicts an illustrative graphical user interface for assessing the accuracy of the optical tracking system in accordance with an embodiment.

### DETAILED DESCRIPTION

For the purposes of this disclosure, the term “implant” is used to refer to a prosthetic device or structure manufactured to replace or enhance a biological structure. For example, in a total hip replacement procedure a prosthetic acetabular cup (implant) is used to replace or enhance a patients worn or damaged acetabulum. While the term “implant” is generally considered to denote a man-made structure (as contrasted with a transplant), for the purposes of this specification an implant can include a biological tissue or material transplanted to replace or enhance a biological structure.

For the purposes of this disclosure, the term “real-time” is used to refer to calculations or operations performed on-the-fly as events occur or input is received by the operable system. However, the use of the term “real-time” is not intended to preclude operations that cause some latency between input and response, so long as the latency is an unintended consequence induced by the performance characteristics of the machine.

Although much of this disclosure refers to surgeons or other medical professionals by specific job title or role, nothing in this disclosure is intended to be limited to a specific job title or function. Surgeons or medical professionals can include any doctor, nurse, medical professional, or technician. Any of these terms or job titles can be used interchangeably with the user of the systems disclosed herein unless otherwise explicitly demarcated. For example, a reference to a surgeon also could apply, in some embodiments to a technician or nurse.

The systems, methods, and devices disclosed herein are particularly well adapted for surgical procedures that utilize surgical navigation systems, such as the CORI® surgical navigation system. CORI is a registered trademark of BLUE BELT TECHNOLOGIES, INC. of Pittsburgh, PA, which is a subsidiary of SMITH & NEPHEW, INC. of Memphis, TN.

### CASS Ecosystem Overview

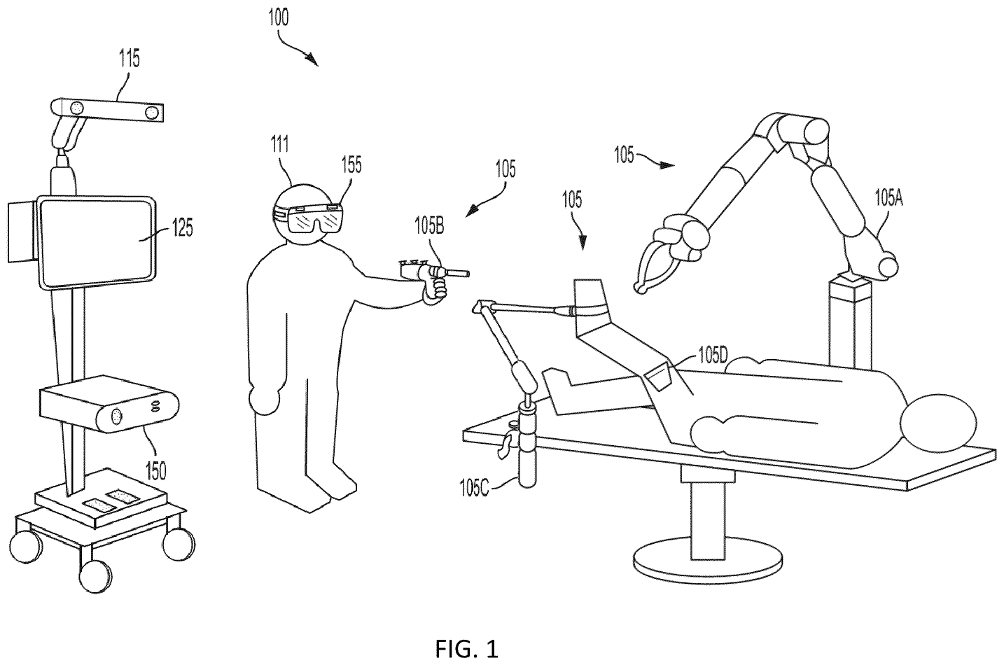

FIG. 1 provides an illustration of an example computer-assisted surgical system (CASS) 100, according to some embodiments. As described in further detail in the sections that follow, the CASS uses computers, robotics, and imaging technology to aid surgeons in performing orthopedic surgery procedures such as total knee arthroplasty (TKA) or THA. For example, surgical navigation systems can aid surgeons in locating patient anatomical structures, guiding surgical instruments, and implanting medical devices with a high degree of accuracy. Surgical navigation systems such as the CASS 100 often employ various forms of computing technology to perform a wide variety of standard and minimally invasive surgical procedures and techniques. Moreover, these systems allow surgeons to more accurately plan, track and navigate the placement of instruments and implants relative to the body of a patient, as well as conduct pre-operative and intra-operative body imaging.

An Effector Platform 105 positions surgical tools relative to a patient during surgery. The exact components of the Effector Platform 105 will vary, depending on the embodiment employed. For example, for a knee surgery, the Effector Platform 105 may include an End Effector 105B that holds surgical tools or instruments during their use. The End Effector 105B may be a handheld device or instrument used by the surgeon (e.g., a CORI® hand piece or a cutting guide or jig) or, alternatively, the End Effector 105B can include a device or instrument held or positioned by a Robotic Arm 105A. While one Robotic Arm 105A is illustrated in FIG. 1, in some embodiments there may be multiple devices. As examples, there may be one Robotic Arm 105A on each side of an operating table T or two devices on one side of the table T. The Robotic Arm 105A may be mounted directly to the table T, be located next to the table T on a floor platform (not shown), mounted on a floor-to-ceiling pole, or mounted on a wall or ceiling of an operating room. The floor platform may be fixed or moveable. In one particular embodiment, the robotic arm 105A is mounted on a floor-to-ceiling pole located between the patient's legs or feet. In some embodiments, the End Effector 105B may include a suture holder or a stapler to assist in closing wounds. Further, in the case of two robotic arms 105A, the surgical computer 150 can drive the robotic arms 105A to work together to suture the wound at closure. Alternatively, the surgical computer 150 can drive one or more robotic arms 105A to staple the wound at closure.

The Effector Platform 105 can include a Limb Positioner 105C for positioning the patient's limbs during surgery. One example of a Limb Positioner 105C is the SMITH AND NEPHEW SPIDER2 system. The Limb Positioner 105C may be operated manually by the surgeon or alternatively change limb positions based on instructions received from the Surgical Computer 150 (described below). While one Limb Positioner 105C is illustrated in FIG. 1, in some embodiments there may be multiple devices. As examples, there may be one Limb Positioner 105C on each side of the operating table T or two devices on one side of the table T. The Limb Positioner 105C may be mounted directly to the table T, be located next to the table T on a floor platform (not shown), mounted on a pole, or mounted on a wall or ceiling of an operating room. In some embodiments, the Limb Positioner 105C can be used in non-conventional ways, such as a retractor or specific bone holder. The Limb Positioner 105C may include, as examples, an ankle boot, a soft tissue clamp, a bone clamp, or a soft-tissue retractor spoon, such as a hooked, curved, or angled blade. In some embodiments, the Limb Positioner 105C may include a suture holder to assist in closing wounds.

The Effector Platform 105 may include tools, such as a screwdriver, light or laser, to indicate an axis or plane, bubble level, pin driver, pin puller, plane checker, pointer, finger, or some combination thereof.

Resection Equipment 110 (not shown in FIG. 1) performs bone or tissue resection using, for example, mechanical, ultrasonic, or laser techniques. Examples of Resection Equipment 110 include drilling devices, burring devices, oscillatory sawing devices, vibratory impaction devices, reamers, ultrasonic bone cutting devices, radio frequency ablation devices, reciprocating devices (such as a rasp or broach), and laser ablation systems. In some embodiments, the Resection Equipment 110 is held and operated by the surgeon during surgery. In other embodiments, the Effector Platform 105 may be used to hold the Resection Equipment 110 during use.

The Effector Platform 105 also can include a cutting guide or jig 105D that is used to guide saws or drills used to resect tissue during surgery. Such cutting guides 105D can be formed integrally as part of the Effector Platform 105 or Robotic Arm 105A, or cutting guides can be separate structures that can be matingly and/or removably attached to the Effector Platform 105 or Robotic Arm 105A. The Effector Platform 105 or Robotic Arm 105A can be controlled by the CASS 100 to position a cutting guide or jig 105D adjacent to the patient's anatomy in accordance with a pre-operatively or intraoperatively developed surgical plan such that the cutting guide or jig will produce a precise bone cut in accordance with the surgical plan.

The Tracking System 115 uses one or more sensors to collect real-time position data that locates the patient's anatomy and surgical instruments. For example, for TKA procedures, the Tracking System may provide a location and orientation of the End Effector 105B during the procedure. In addition to positional data, data from the Tracking System 115 also can be used to infer velocity/acceleration of anatomy/instrumentation, which can be used for tool control. In some embodiments, the Tracking System 115 may use a tracker array attached to the End Effector 105B to determine the location and orientation of the End Effector 105B. The position of the End Effector 105B may be inferred based on the position and orientation of the Tracking System 115 and a known relationship in three-dimensional space between the Tracking System 115 and the End Effector 105B. Various types of tracking systems may be used in various embodiments of the present invention including, without limitation, Infrared (IR) tracking systems, electromagnetic (EM) tracking systems, video or image based tracking systems, and ultrasound registration and tracking systems. Using the data provided by the tracking system 115, the surgical computer 150 can detect objects and prevent collision. For example, the surgical computer 150 can prevent the Robotic Arm 105A and/or the End Effector 105B from colliding with soft tissue.

Any suitable tracking system can be used for tracking surgical objects and patient anatomy in the surgical theatre. For example, a combination of IR and visible light cameras can be used in an array. Various illumination sources, such as an IR LED light source, can illuminate the scene allowing three-dimensional imaging to occur. In some embodiments, this can include stereoscopic, tri-scopic, quad-scopic, etc. imaging. In addition to the camera array, which in some embodiments is affixed to a cart, additional cameras can be placed throughout the surgical theatre. For example, handheld tools or headsets worn by operators/surgeons can include imaging capability that communicates images back to a central processor to correlate those images with images captured by the camera array. This can give a more robust image of the environment for modeling using multiple perspectives. Furthermore, some imaging devices may be of suitable resolution or have a suitable perspective on the scene to pick up information stored in quick response (QR) codes or barcodes. This can be helpful in identifying specific objects not manually registered with the system. In some embodiments, the camera may be mounted on the Robotic Arm 105A.

Although, as discussed herein, the majority of tracking and/or navigation techniques utilize image-based tracking systems (e.g., IR tracking systems, video or image based tracking systems, etc.). However, electromagnetic (EM) based tracking systems are becoming more common for a variety of reasons. For example, implantation of standard optical trackers requires tissue resection (e.g., down to the cortex) as well as subsequent drilling and driving of cortical pins. Additionally, because optical trackers require a direct line of sight with a tracking system, the placement of such trackers may need to be far from the surgical site to ensure they do not restrict the movement of a surgeon or medical professional.

In addition to optical tracking, certain features of objects can be tracked by registering physical properties of the object and associating them with objects that can be tracked, such as fiducial marks fixed to a tool or bone. For example, a surgeon may perform a manual registration process whereby a tracked tool and a tracked bone can be manipulated relative to one another. By impinging the tip of the tool against the surface of the bone, a three-dimensional surface can be mapped for that bone that is associated with a position and orientation relative to the frame of reference of that fiducial mark. By optically tracking the position and orientation (pose) of the fiducial mark associated with that bone, a model of that surface can be tracked with an environment through extrapolation.

The registration process that registers the CASS 100 to the relevant anatomy of the patient also can involve the use of anatomical landmarks, such as landmarks on a bone or cartilage. For example, the CASS 100 can include a 3D model of the relevant bone or joint and the surgeon can intraoperatively collect data regarding the location of bony landmarks on the patient's actual bone using a probe that is connected to the CASS. Bony landmarks can include, for example, the medial malleolus and lateral malleolus, the ends of the proximal femur and distal tibia, and the center of the hip joint. The CASS 100 can compare and register the location data of bony landmarks collected by the surgeon with the probe with the location data of the same landmarks in the 3D model. Alternatively, the CASS 100 can construct a 3D model of the bone or joint without pre-operative image data by using location data of bony landmarks and the bone surface that are collected by the surgeon using a CASS probe or other means. The registration process also can include determining various axes of a joint. For example, for a TKA the surgeon can use the CASS 100 to determine the anatomical and mechanical axes of the femur and tibia. The surgeon and the CASS 100 can identify the center of the hip joint by moving the patient's leg in a spiral direction (i.e., circumduction) so the CASS can determine where the center of the hip joint is located.

A Tissue Navigation System 120 (not shown in FIG. 1) provides the surgeon with intraoperative, real-time visualization for the patient's bone, cartilage, muscle, nervous, and/or vascular tissues surrounding the surgical area. Examples of systems that may be employed for tissue navigation include fluorescent imaging systems and ultrasound systems.

The Display 125 provides graphical user interfaces (GUIs) that display images collected by the Tissue Navigation System 120 as well other information relevant to the surgery. For example, in one embodiment, the Display 125 overlays image information collected from various modalities (e.g., CT, MRI, X-ray, fluorescent, ultrasound, etc.) collected pre-operatively or intra-operatively to give the surgeon various views of the patient's anatomy as well as real-time conditions. The Display 125 may include, for example, one or more computer monitors. As an alternative or supplement to the Display 125, one or more members of the surgical staff may wear an Augmented Reality (AR) Head Mounted Device (HMD). For example, in FIG. 1 the Surgeon 111 is wearing an AR HMD 155 that may, for example, overlay pre-operative image data on the patient or provide surgical planning suggestions. In one embodiment, a tracker array-mounted surgical tool could be detected by both the IR camera and an AR headset (HMD) using sensor fusion techniques without the need for any “intermediate” calibration rigs. This near-depth, time-of-flight sensing camera located in the HMD could be used for hand/gesture detection. The headset's sensor API can be used to expose IR and depth image data and carryout image processing using, for example, C++ with OpenCV. This approach allows the relationship between the CASS and the virtual coordinate frame to be determined and the headset sensor data (i.e., IR in combination with depth images) to isolate the CASS tracker arrays. The image processing system on the HMD can locate the surgical tool in a fixed holographic world frame and the CASS IR camera can locate the surgical tool relative to its camera coordinate frame. This relationship can be used to calculate a calibration matrix that relates the CASS IR camera coordinate frame to the fixed holographic world frame. This means that if a calibration matrix has previously been calculated, the surgical tool no longer needs to be visible to the AR headset. However, a recalculation may be necessary if the CASS camera is accidentally moved in the workflow. Various example uses of the AR HMD 155 in surgical procedures are detailed in the sections that follow.

Surgical Computer 150 provides control instructions to various components of the CASS 100, collects data from those components, and provides general processing for various data needed during surgery. In some embodiments, the Surgical Computer 150 is a general purpose computer. In other embodiments, the Surgical Computer 150 may be a parallel computing platform that uses multiple central processing units (CPUs) or graphics processing units (GPU) to perform processing. In some embodiments, the Surgical Computer 150 is connected to a remote server over one or more computer networks (e.g., the Internet). The remote server can be used, for example, for storage of data or execution of computationally intensive processing tasks.

Various techniques generally known in the art can be used for connecting the Surgical Computer 150 to the other components of the CASS 100. Moreover, the computers can connect to the Surgical Computer 150 using a mix of technologies. For example, the End Effector 105B may connect to the Surgical Computer 150 over a wired (i.e., serial) connection. The Tracking System 115, Tissue Navigation System 120, and Display 125 can similarly be connected to the Surgical Computer 150 using wired connections. Alternatively, the Tracking System 115, Tissue Navigation System 120, and Display 125 may connect to the Surgical Computer 150 using wireless technologies such as, without limitation, Wi-Fi, Bluetooth, Near Field Communication (NFC), or ZigBee.

### Powered Impaction and Acetabular Reamer Devices

Part of the flexibility of the CASS design described above with respect to FIG. 1 is that additional or alternative devices can be added to the CASS 100 as necessary to support particular surgical procedures. For example, in the context of hip surgeries, the CASS 100 may include a powered impaction device. Impaction devices are designed to repeatedly apply an impaction force that the surgeon can use to perform activities such as implant alignment. For example, within a THA, a surgeon will often insert a prosthetic acetabular cup into the implant host's acetabulum using an impaction device. Although impaction devices can be manual in nature (e.g., operated by the surgeon striking an impactor with a mallet), powered impaction devices are generally easier and quicker to use in the surgical setting. Powered impaction devices may be powered, for example, using a battery attached to the device. Various attachment pieces may be connected to the powered impaction device to allow the impaction force to be directed in various ways as needed during surgery. Also, in the context of hip surgeries, the CASS 100 may include a powered, robotically controlled end effector to ream the acetabulum to accommodate an acetabular cup implant.

In a robotically-assisted THA, the patient's anatomy can be registered to the CASS 100 using CT or other image data, the identification of anatomical landmarks, tracker arrays attached to the patient's bones, and one or more cameras. Tracker arrays can be mounted on the iliac crest using clamps and/or bone pins and such trackers can be mounted externally through the skin or internally (either posterolaterally or anterolaterally) through the incision made to perform the THA. For a THA, the CASS 100 can utilize one or more femoral cortical screws inserted into the proximal femur as checkpoints to aid in the registration process. The CASS 100 also can utilize one or more checkpoint screws inserted into the pelvis as additional checkpoints to aid in the registration process. Femoral tracker arrays can be secured to or mounted in the femoral cortical screws. The CASS 100 can employ steps where the registration is verified using a probe that the surgeon precisely places on key areas of the proximal femur and pelvis identified for the surgeon on the display 125. Trackers can be located on the robotic arm 105A or end effector 105B to register the arm and/or end effector to the CASS 100. The verification step also can utilize proximal and distal femoral checkpoints. The CASS 100 can utilize color prompts or other prompts to inform the surgeon that the registration process for the relevant bones and the robotic arm 105A or end effector 105B has been verified to a certain degree of accuracy (e.g., within 1 mm).

For a THA, the CASS 100 can include a broach tracking option using femoral arrays to allow the surgeon to intraoperatively capture the broach position and orientation and calculate hip length and offset values for the patient. Based on information provided about the patient's hip joint and the planned implant position and orientation after broach tracking is completed, the surgeon can make modifications or adjustments to the surgical plan.

For a robotically-assisted THA, the CASS 100 can include one or more powered reamers connected or attached to a robotic arm 105A or end effector 105B that prepares the pelvic bone to receive an acetabular implant according to a surgical plan. The robotic arm 105A and/or end effector 105B can inform the surgeon and/or control the power of the reamer to ensure that the acetabulum is being resected (reamed) in accordance with the surgical plan. For example, if the surgeon attempts to resect bone outside of the boundary of the bone to be resected in accordance with the surgical plan, the CASS 100 can power off the reamer or instruct the surgeon to power off the reamer. The CASS 100 can provide the surgeon with an option to turn off or disengage the robotic control of the reamer. The display 125 can depict the progress of the bone being resected (reamed) as compared to the surgical plan using different colors. The surgeon can view the display of the bone being resected (reamed) to guide the reamer to complete the reaming in accordance with the surgical plan. The CASS 100 can provide visual or audible prompts to the surgeon to warn the surgeon that resections are being made that are not in accordance with the surgical plan.

Following reaming, the CASS 100 can employ a manual or powered impactor that is attached or connected to the robotic arm 105A or end effector 105B to impact trial implants and final implants into the acetabulum. The robotic arm 105A and/or end effector 105B can be used to guide the impactor to impact the trial and final implants into the acetabulum in accordance with the surgical plan. The CASS 100 can cause the position and orientation of the trial and final implants vis-à-vis the bone to be displayed to inform the surgeon as to how the trial and final implant's orientation and position compare to the surgical plan, and the display 125 can show the implant's position and orientation as the surgeon manipulates the leg and hip. The CASS 100 can provide the surgeon with the option of re-planning and re-doing the reaming and implant impaction by preparing a new surgical plan if the surgeon is not satisfied with the original implant position and orientation.

Preoperatively, the CASS 100 can develop a proposed surgical plan based on a three dimensional model of the hip joint and other information specific to the patient, such as the mechanical and anatomical axes of the leg bones, the epicondylar axis, the femoral neck axis, the dimensions (e.g., length) of the femur and hip, the midline axis of the hip joint, the ASIS axis of the hip joint, and the location of anatomical landmarks such as the lesser trochanter landmarks, the distal landmark, and the center of rotation of the hip joint. The CASS-developed surgical plan can provide a recommended optimal implant size and implant position and orientation based on the three dimensional model of the hip joint and other information specific to the patient. The CASS-developed surgical plan can include proposed details on offset values, inclination and anteversion values, center of rotation, cup size, medialization values, superior-inferior fit values, femoral stem sizing and length.

For a THA, the CASS-developed surgical plan can be viewed preoperatively and intraoperatively, and the surgeon can modify CASS-developed surgical plan preoperatively or intraoperatively. The CASS-developed surgical plan can display the planned resection to the hip joint and superimpose the planned implants onto the hip joint based on the planned resections. The CASS 100 can provide the surgeon with options for different surgical workflows that will be displayed to the surgeon based on a surgeon's preference. For example, the surgeon can choose from different workflows based on the number and types of anatomical landmarks that are checked and captured and/or the location and number of tracker arrays used in the registration process.

According to some embodiments, a powered impaction device used with the CASS 100 may operate with a variety of different settings. In some embodiments, the surgeon adjusts settings through a manual switch or other physical mechanism on the powered impaction device. In other embodiments, a digital interface may be used that allows setting entry, for example, via a touchscreen on the powered impaction device. Such a digital interface may allow the available settings to vary based, for example, on the type of attachment piece connected to the power attachment device. In some embodiments, rather than adjusting the settings on the powered impaction device itself, the settings can be changed through communication with a robot or other computer system within the CASS 100. Such connections may be established using, for example, a Bluetooth or Wi-Fi networking module on the powered impaction device. In another embodiment, the impaction device and end pieces may contain features that allow the impaction device to be aware of what end piece (cup impactor, broach handle, etc.) is attached with no action required by the surgeon, and adjust the settings accordingly. This may be achieved, for example, through a QR code, barcode, RFID tag, or other method.

Examples of the settings that may be used include cup impaction settings (e.g., single direction, specified frequency range, specified force and/or energy range); broach impaction settings (e.g., dual direction/oscillating at a specified frequency range, specified force and/or energy range); femoral head impaction settings (e.g., single direction/single blow at a specified force or energy); and stem impaction settings (e.g., single direction at specified frequency with a specified force or energy). Additionally, in some embodiments, the powered impaction device includes settings related to acetabular liner impaction (e.g., single direction/single blow at a specified force or energy). There may be a plurality of settings for each type of liner such as poly, ceramic, oxinium, or other materials. Furthermore, the powered impaction device may offer settings for different bone quality based on preoperative testing/imaging/knowledge and/or intraoperative assessment by surgeon. In some embodiments, the powered impactor device may have a dual function. For example, the powered impactor device not only could provide reciprocating motion to provide an impact force, but also could provide reciprocating motion for a broach or rasp.

In some embodiments, the powered impaction device includes feedback sensors that gather data during instrument use and send data to a computing device, such as a controller within the device or the Surgical Computer 150. This computing device can then record the data for later analysis and use. Examples of the data that may be collected include, without limitation, sound waves, the predetermined resonance frequency of each instrument, reaction force or rebound energy from patient bone, location of the device with respect to imaging (e.g., fluoro, CT, ultrasound, MRI, etc.) registered bony anatomy, and/or external strain gauges on bones.

Once the data is collected, the computing device may execute one or more algorithms in real-time or near real-time to aid the surgeon in performing the surgical procedure. For example, in some embodiments, the computing device uses the collected data to derive information such as the proper final broach size (femur); when the stem is fully seated (femur side); or when the cup is seated (depth and/or orientation) for a THA. Once the information is known, it may be displayed for the surgeon's review, or it may be used to activate haptics or other feedback mechanisms to guide the surgical procedure.

Additionally, the data derived from the aforementioned algorithms may be used to drive operation of the device. For example, during insertion of a prosthetic acetabular cup with a powered impaction device, the device may automatically extend an impaction head (e.g., an end effector) moving the implant into the proper location, or turn the power off to the device once the implant is fully seated. In one embodiment, the derived information may be used to automatically adjust settings for quality of bone where the powered impaction device should use less power to mitigate femoral/acetabular/pelvic fracture or damage to surrounding tissues.

### Robotic Arm

In some embodiments, the CASS 100 includes a robotic arm 105A that serves as an interface to stabilize and hold a variety of instruments used during the surgical procedure. For example, in the context of a hip surgery, these instruments may include, without limitation, retractors, a sagittal or reciprocating saw, the reamer handle, the cup impactor, the broach handle, and the stem inserter. The robotic arm 105A may have multiple degrees of freedom (like a Spider device), and have the ability to be locked in place (e.g., by a press of a button, voice activation, a surgeon removing a hand from the robotic arm, or other method).

In some embodiments, movement of the robotic arm 105A may be effectuated by use of a control panel built into the robotic arm system. For example, a display screen may include one or more input sources, such as physical buttons or a user interface having one or more icons, that direct movement of the robotic arm 105A. The surgeon or other healthcare professional may engage with the one or more input sources to position the robotic arm 105A when performing a surgical procedure.

A tool or an end effector 105B attached or integrated into a robotic arm 105A may include, without limitation, a burring device, a scalpel, a cutting device, a retractor, a joint tensioning device, or the like. In embodiments in which an end effector 105B is used, the end effector may be positioned at the end of the robotic arm 105A such that any motor control operations are performed within the robotic arm system. In embodiments in which a tool is used, the tool may be secured at a distal end of the robotic arm 105A, but motor control operation may reside within the tool itself.

The robotic arm 105A may be motorized internally to both stabilize the robotic arm, thereby preventing it from falling and hitting the patient, surgical table, surgical staff, etc., and to allow the surgeon to move the robotic arm without having to fully support its weight. While the surgeon is moving the robotic arm 105A, the robotic arm may provide some resistance to prevent the robotic arm from moving too fast or having too many degrees of freedom active at once. The position and the lock status of the robotic arm 105A may be tracked, for example, by a controller or the Surgical Computer 150.

In some embodiments, the robotic arm 105A can be moved by hand (e.g., by the surgeon) or with internal motors into its ideal position and orientation for the task being performed. In some embodiments, the robotic arm 105A may be enabled to operate in a “free” mode that allows the surgeon to position the arm into a desired position without being restricted. While in the free mode, the position and orientation of the robotic arm 105A may still be tracked as described above. In one embodiment, certain degrees of freedom can be selectively released upon input from user (e.g., surgeon) during specified portions of the surgical plan tracked by the Surgical Computer 150. Designs in which a robotic arm 105A is internally powered through hydraulics or motors or provides resistance to external manual motion through similar means can be described as powered robotic arms, while arms that are manually manipulated without power feedback, but which may be manually or automatically locked in place, may be described as passive robotic arms.

A robotic arm 105A or end effector 105B can include a trigger or other means to control the power of a saw or drill. Engagement of the trigger or other means by the surgeon can cause the robotic arm 105A or end effector 105B to transition from a motorized alignment mode to a mode where the saw or drill is engaged and powered on. Additionally, the CASS 100 can include a foot pedal (not shown) that causes the system to perform certain functions when activated. For example, the surgeon can activate the foot pedal to instruct the CASS 100 to place the robotic arm 105A or end effector 105B in an automatic mode that brings the robotic arm or end effector into the proper position with respect to the patient's anatomy in order to perform the necessary resections. The CASS 100 also can place the robotic arm 105A or end effector 105B in a collaborative mode that allows the surgeon to manually manipulate and position the robotic arm or end effector into a particular location. The collaborative mode can be configured to allow the surgeon to move the robotic arm 105A or end effector 105B medially or laterally, while restricting movement in other directions. As discussed, the robotic arm 105A or end effector 105B can include a cutting device (saw, drill, and burr) or a cutting guide or jig 105D that will guide a cutting device. In other embodiments, movement of the robotic arm 105A or robotically controlled end effector 105B can be controlled entirely by the CASS 100 without any, or with only minimal, assistance or input from a surgeon or other medical professional. In still other embodiments, the movement of the robotic arm 105A or robotically controlled end effector 105B can be controlled remotely by a surgeon or other medical professional using a control mechanism separate from the robotic arm or robotically controlled end effector device, for example using a joystick or interactive monitor or display control device.

The examples below describe uses of the robotic device in the context of a hip surgery; however, it should be understood that the robotic arm may have other applications for surgical procedures involving knees, shoulders, etc. One example of use of a robotic arm in the context of forming an anterior cruciate ligament (ACL) graft tunnel is described in WIPO Publication No. WO 2020/047051, filed Aug. 28, 2019, entitled “Robotic Assisted Ligament Graft Placement and Tensioning,” the entirety of which is incorporated herein by reference.

A robotic arm 105A may be used for holding the retractor. For example in one embodiment, the robotic arm 105A may be moved into the desired position by the surgeon. At that point, the robotic arm 105A may lock into place. In some embodiments, the robotic arm 105A is provided with data regarding the patient's position, such that if the patient moves, the robotic arm can adjust the retractor position accordingly. In some embodiments, multiple robotic arms may be used, thereby allowing multiple retractors to be held or for more than one activity to be performed simultaneously (e.g., retractor holding & reaming).

The robotic arm 105A may also be used to help stabilize the surgeon's hand while making a femoral neck cut. In this application, control of the robotic arm 105A may impose certain restrictions to prevent soft tissue damage from occurring. For example, in one embodiment, the Surgical Computer 150 tracks the position of the robotic arm 105A as it operates. If the tracked location approaches an area where tissue damage is predicted, a command may be sent to the robotic arm 105A causing it to stop. Alternatively, where the robotic arm 105A is automatically controlled by the Surgical Computer 150, the Surgical Computer may ensure that the robotic arm is not provided with any instructions that cause it to enter areas where soft tissue damage is likely to occur. The Surgical Computer 150 may impose certain restrictions on the surgeon to prevent the surgeon from reaming too far into the medial wall of the acetabulum or reaming at an incorrect angle or orientation.

In some embodiments, the robotic arm 105A may be used to hold a cup impactor at a desired angle or orientation during cup impaction. When the final position has been achieved, the robotic arm 105A may prevent any further seating to prevent damage to the pelvis.

The surgeon may use the robotic arm 105A to position the broach handle at the desired position and allow the surgeon to impact the broach into the femoral canal at the desired orientation. In some embodiments, once the Surgical Computer 150 receives feedback that the broach is fully seated, the robotic arm 105A may restrict the handle to prevent further advancement of the broach.

The robotic arm 105A may also be used for resurfacing applications. For example, the robotic arm 105A may stabilize the surgeon while using traditional instrumentation and provide certain restrictions or limitations to allow for proper placement of implant components (e.g., guide wire placement, chamfer cutter, sleeve cutter, plan cutter, etc.). Where only a burr is employed, the robotic arm 105A may stabilize the surgeon's handpiece and may impose restrictions on the handpiece to prevent the surgeon from removing unintended bone in contravention of the surgical plan.

The robotic arm 105A may be a passive arm. As an example, the robotic arm 105A may be a CIRQ robot arm available from Brainlab AG. CIRQ is a registered trademark of Brainlab AG, Olof-Palme-Str. 9 81829, München, FED REP of GERMANY. In one particular embodiment, the robotic arm 105A is an intelligent holding arm as disclosed in U.S. patent application Ser. No. 15/525,585 to Krinninger et al., U.S. patent application Ser. No. 15/561,042 to Nowatschin et al., U.S. patent application Ser. No. 15/561,048 to Nowatschin et al., and U.S. Pat. No. 10,342,636 to Nowatschin et al., the entire contents of each of which is herein incorporated by reference.

### Open Versus Closed Digital Ecosystems

In some embodiments, the CASS 100 is designed to operate as a self-contained or “closed” digital ecosystem. Each component of the CASS 100 is specifically designed to be used in the closed ecosystem, and data is generally not accessible to devices outside of the digital ecosystem. For example, in some embodiments, each component includes software or firmware that implements proprietary protocols for activities such as communication, storage, security, etc. The concept of a closed digital ecosystem may be desirable for a company that wants to control all components of the CASS 100 to ensure that certain compatibility, security, and reliability standards are met. For example, the CASS 100 can be designed such that a new component cannot be used with the CASS unless it is certified by the company.

In other embodiments, the CASS 100 is designed to operate as an “open” digital ecosystem. In these embodiments, components may be produced by a variety of different companies according to standards for activities, such as communication, storage, and security. Thus, by using these standards, any company can freely build an independent, compliant component of the CASS platform. Data may be transferred between components using publicly available application programming interfaces (APIs) and open, shareable data formats.

To illustrate one type of recommendation that may be performed with the CASS 100, a technique for optimizing surgical parameters is disclosed below. The term “optimization” in this context means selection of parameters that are optimal based on certain specified criteria. In an extreme case, optimization can refer to selecting optimal parameter(s) based on data from the entire episode of care, including any pre-operative data, the state of CASS data at a given point in time, and post-operative goals. Moreover, optimization may be performed using historical data, such as data generated during past surgeries involving, for example, the same surgeon, past patients with physical characteristics similar to the current patient, or the like.

The optimized parameters may depend on the portion of the patient's anatomy to be operated on. For example, for knee surgeries, the surgical parameters may include positioning information for the femoral and tibial component including, without limitation, rotational alignment (e.g., varus/valgus rotation, external rotation, flexion rotation for the femoral component, posterior slope of the tibial component), resection depths (e.g., varus knee, valgus knee), and implant type, size and position. The positioning information may further include surgical parameters for the combined implant, such as overall limb alignment, combined tibiofemoral hyperextension, and combined tibiofemoral resection. Additional examples of parameters that could be optimized for a given TKA femoral implant by the CASS 100 include the following:

| | | Exemplary |
|---|---|---|
| Parameter | Reference | Recommendation (s) |
| Size | Posterior | The largest sized |
| | | implant that does not |
| | | overhang medial/lateral |
| | | bone edges or overhang |
| | | the anterior femur. |
| | | A size that does not |
| | | result in overstuffing |
| | | the patella femoral |
| | | joint |
| Implant Position - | Medial/lateral cortical | Center the implant |
| Medial Lateral | bone edges | evenly between the |
| | | medial/lateral cortical |
| | | bone edges |
| Resection Depth - | Distal and posterior | 6 mm of bone |
| Varus Knee | lateral | |
| Resection Depth - | Distal and posterior | 7 mm of bone |
| Valgus Knee | medial | |
| Rotation - | Mechanical Axis | 1° varus |
| Varus/Valgus | | |
| Rotation - External | Transepicondylar Axis | 1° external from the |
| | | transepicondylar axis |
| Rotation - Flexion | Mechanical Axis | 3° flexed |

Additional examples of parameters that could be optimized for a given TKA tibial implant by the CASS 100 include the following:

| | | Exemplary |
|---|---|---|
| Parameter | Reference | Recommendation (s) |
| Size | Posterior | The largest sized |
| | | implant that does not |
| | | overhang the medial, |
| | | lateral, anterior, and |
| | | posterior tibial edges |
| Implant Position | Medial/lateral and | Center the implant |
| | anterior/posterior | evenly between the |
| | cortical bone edges | medial/lateral and |
| | | anterior/posterior |
| | | cortical bone edges |
| Resection Depth - | Lateral/Medial | 4 mm of bone |
| Varus Knee | | |
| Resection Depth - | Lateral/Medial | 5 mm of bone |
| Valgus Knee | | |
| Rotation - | Mechanical Axis | 1° valgus |
| Varus/Valgus | | |
| Rotation - External | Tibial Anterior | 1° external from the |
| | Posterior Axis | tibial anterior paxis |
| Posterior Slope | Mechanical Axis | 3° posterior slope |

For hip surgeries, the surgical parameters may comprise femoral neck resection location and angle, cup inclination angle, cup anteversion angle, cup depth, femoral stem design, femoral stem size, fit of the femoral stem within the canal, femoral offset, leg length, and femoral version of the implant.

Shoulder parameters may include, without limitation, humeral resection depth/angle, humeral stem version, humeral offset, glenoid version and inclination, as well as reverse shoulder parameters such as humeral resection depth/angle, humeral stem version, Glenoid tilt/version, glenosphere orientation, glenosphere offset and offset direction.

Various conventional techniques exist for optimizing surgical parameters. However, these techniques are typically computationally intensive and, thus, parameters often need to be determined pre-operatively. As a result, the surgeon is limited in his or her ability to make modifications to optimized parameters based on issues that may arise during surgery. Moreover, conventional optimization techniques typically operate in a “black box” manner with little or no explanation regarding recommended parameter values. Thus, if the surgeon decides to deviate from a recommended parameter value, the surgeon typically does so without a full understanding of the effect of that deviation on the rest of the surgical workflow, or the impact of the deviation on the patient's post-surgery quality of life.

### Marker Based Optical 3D Tracking System Calibration

Marker-based optical 3D tracking systems can be used to track the position and orientation (i.e., pose) of rigid bodies on which specific fiducial markers are attached. Such systems are often equipped with a narrow infrared (IR) bandpass filter so that only the fiducials are visible, with the rest of the image being empty (e.g., black).

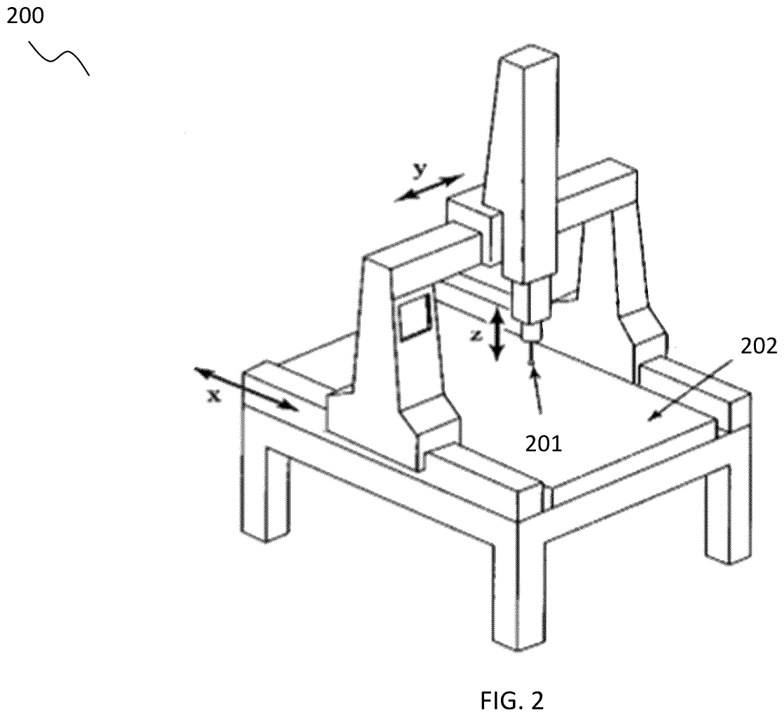

In a manufacturing calibration for a fiducial-based optical tracking system, a Coordinate Measurement Machine (CMM) can be used to move marker fiducials within a working volume. FIG. 2 depicts an illustrative Coordinate Measurement Machine 200 in accordance with an embodiment. The CMM can include an end-effector 201 which may be moved to numerous points in space, and the tracking system may simultaneously acquire the marker positions in a sensor referential. The CMM can include a worktable 202 which aids in defining the space. The sensors can be charge-coupled device (CCD) and/or complementary metal-oxide-semiconductor (CMOS) sensors. A calibration technique (e.g., bundle adjustment) can be used to determine the extrinsic, and optionally intrinsic, parameters of the camera(s). One advantage of performing calibration using a CMM may be superior accuracy. Drawbacks of a CMM can include the process duration, the cost of the CMM, and the usability (i.e., a CMM often weighs several tons).

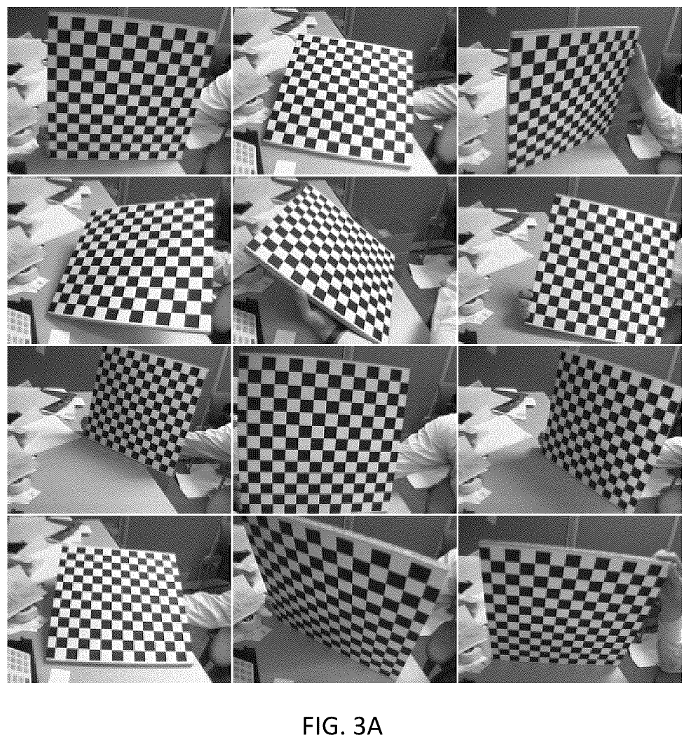

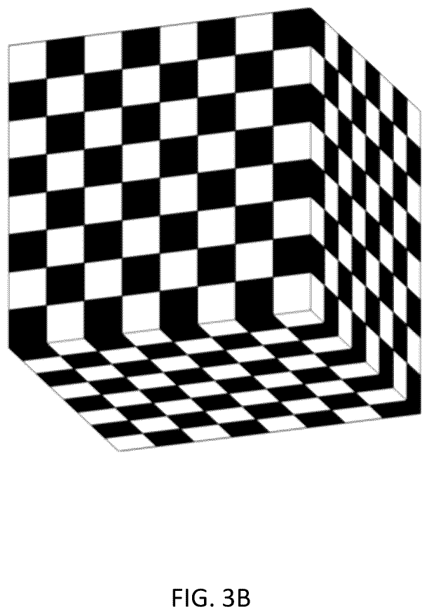

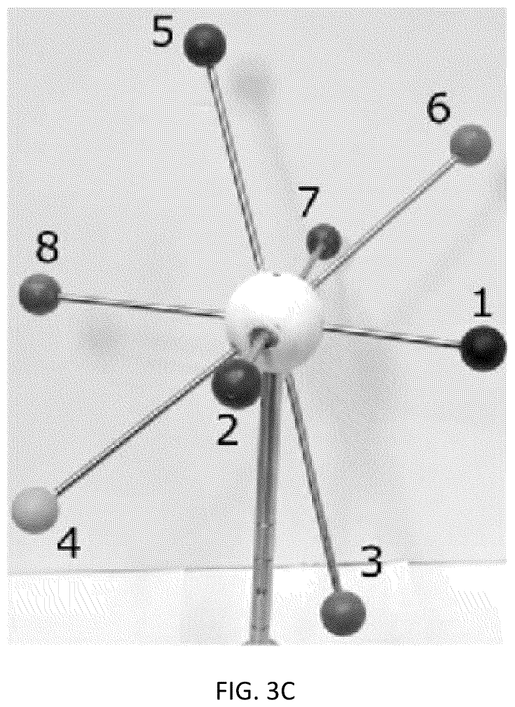

Traditional in-situ camera calibration techniques have frequently used chessboard detection. FIG. 3A illustrate how a chessboard can be moved by an operator in front of the camera for calibration. As illustrated in FIG. 3B, chessboards can also be applied to non-planar (e.g., a cubic) calibration boards. The chessboard intersection points can be detected and, by knowing the metric size of the grid, the camera's intrinsic and/or extrinsic parameters can be estimated. Some advantages of using these techniques include simplicity in implementation and affordability. Disadvantages can include inaccuracy and speed. For example, with some systems the operator may be forced to choose between carefully moving the chessboard uniformly across a working volume while simultaneously taking care of orienting the chessboard following a multiplicity of angles thereby slowing the calibration process or hurrying the process at the cost of a less accurate calibration. Moreover, chessboard calibration techniques are not commonly used in the field of fiducial-based tracking systems because such systems often have near infrared passing filters which makes the tracking of a black and white grid impractical. Variations of non-planar calibration boards, such as open cubes and/or having varying patterns have also been used for calibration with similar advantages and disadvantages.

Alternative non-planar artifacts have included colored optical elements mounted at known geometries. FIG. 3C illustrates a non-planar artifact with eight colored balls mounted around a core. Such artifacts do not contain the type of fiducials that can be directly tracked by fiducial-based tracking systems.

Artifacts composed of retroreflective fiducials, trackable by a fiducial-based tracking system, have been used for in-situ recalibration purposes by several makers of fiducial-based optical tracking systems. The artifacts and gauges used for calibration are approximately bar-shaped or planar. Such in situ recalibration solutions can require several minutes to be performed if an accurate calibration is desired because an accurate calibration requires the operator to cover the whole tracking system 3D working volume with the gauge while simultaneously taking care of orienting the gauge over a multiplicity of angles.

The systems and methods described herein may allow for in situ (e.g., in an operating room) recalibration in a very short time (e.g., less than one minute). Moreover, the drastically reduced time needed to recalibrate the cameras and the simplified operator procedure may accommodate the performance of camera recalibrations more often (e.g., daily), before any substantial calibration loss due to camera aging occurs, thereby leading to some improvement of the accuracy of the tracking system in real-use conditions.

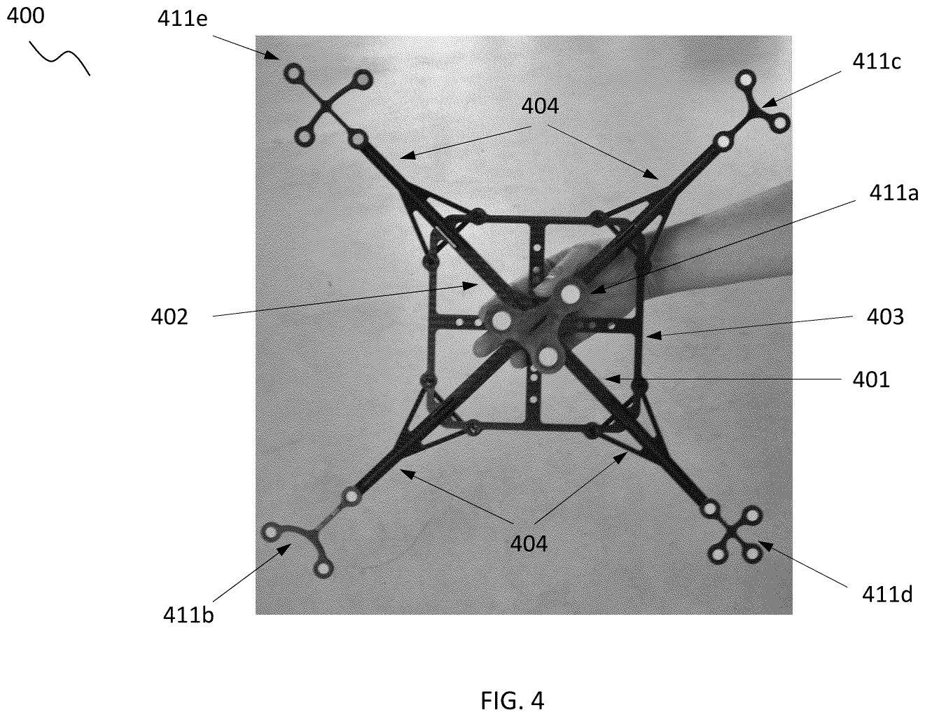

FIG. 4 depicts a non-planar rigid artifact 400 in accordance with an embodiment. The artifact may have a large extension in all three dimensions. In some embodiments, given the three dimensions of the artifact's 400 smallest circumscribed rectangular parallelepiped, the maximal dimension length may be less than four times the minimal dimension length. As described herein, an artifact refers to the virtual rigid body made out of all trackable fiducials attached to the artifact. The fiducials are the elementary objects recognized and tracked by the tracking system. Example fiducials include light emitting diodes (LEDs), retroreflective disks, photoluminescent disks, or retroreflective spheres. In some embodiments, the artifact fiducials are made out of light projected on the surface of a non-planar rigid body. In other embodiments, the artifact fiducials are tags, codes, and/or salient points that are used in computer vision in the visible spectrum.

Parts of the artifact 400 that are not used for tracking, such as a frame or a handle, are not considered for the calculation of the artifact's 400 dimensions. The resulting artifact 400 may allow for improvements over past fiducial-based optical system calibration processes in both accuracy and speed.

The nonplanarity of the artifact 400 may enable acquiring complete calibration data through a fast translation movement of the artifact 400 without having to tilt or rotate the artifact 400 during the process, thereby potentially increasing the calibration process speed and reducing the subjectivity of the process as only translations of the artifact 400 are required (e.g., by an operator or robotic system).

In some embodiments, the artifact 400 can be sized based on the dimensions of the working volume (e.g., at least one twentieth of the used calibration working volume extension). In some embodiments, the artifact 400 can have a known rigidity (i.e., the fiducials must be fixed relative to each other during the whole duration of the calibration process). The tolerated deviations, due to a lack of rigidity, should not exceed the targeted optical system accuracy.

The artifact 400 can be configured in a pyramidal form. Markers 411a-e can be placed at each of the five vertices of the pyramid. In some embodiments, the markers can be Navex markers as disclosed in U.S. patent application Ser. No. 15/273,796, which is hereby incorporated by reference in its entirety.

The markers 411a-e can be manufactured out of a carbon plate. The artifact 400 can be made of, for example and without limitation, 090 carbon epoxy laminate. In some embodiments, the material for the artifact 400 may be chosen to provide some combination of: a low elastic modulus to make the artifact 400 more rigid, a low coefficient of thermal expansion to allow the artifact 400 to perform the calibration process in a large range of room temperatures without needing to compensate for changes in artifact 400 geometry due to thermal expansion, and a low density to ensure the artifact 400 is light enough to be held during the calibration process.

The markers 411a-e on the artifact 400 may have mutually exclusive geometries to allow a straightforward simultaneous 6D tracking of the five markers by standard fiducial-based optical tracking systems (e.g., Atracsys or Creaform stereo cameras). For accurate tracking, at least three fiducials may be required per marker. In some embodiments, three markers may include three retroreflective disks, and two markers may include four retroreflective disks.

The frame of the artifact 400 may include two or more triangular supports 401, 402, which when interfaced form a pyramidal structure to the artifact 400. The frame may further be supported by a base element 403 which holds the two triangular supports 401, 402 in a specified geometry (e.g., perpendicular to one another). The frame may include distal supports 404 which structurally interface the markers 411a-e to the base element 403. In some embodiments, the base element 403 may include a handhold or an interface point for attaching the artifact 400 to a machine.

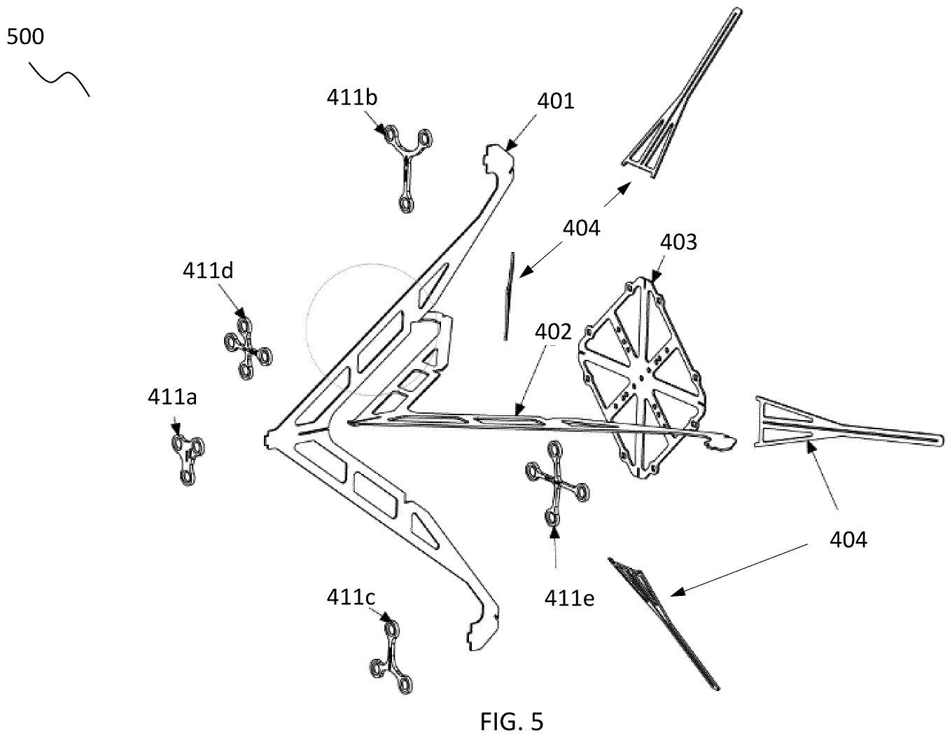

FIG. 5 depicts an illustrative exploded view of the pyramidal artifact 400 of FIG. 3. The components of the frame including the triangular supports 401, 402, base element 403, and distal supports 404 may include grooves or protrusions configured to properly fit the components together in an intended geometry during assembly.

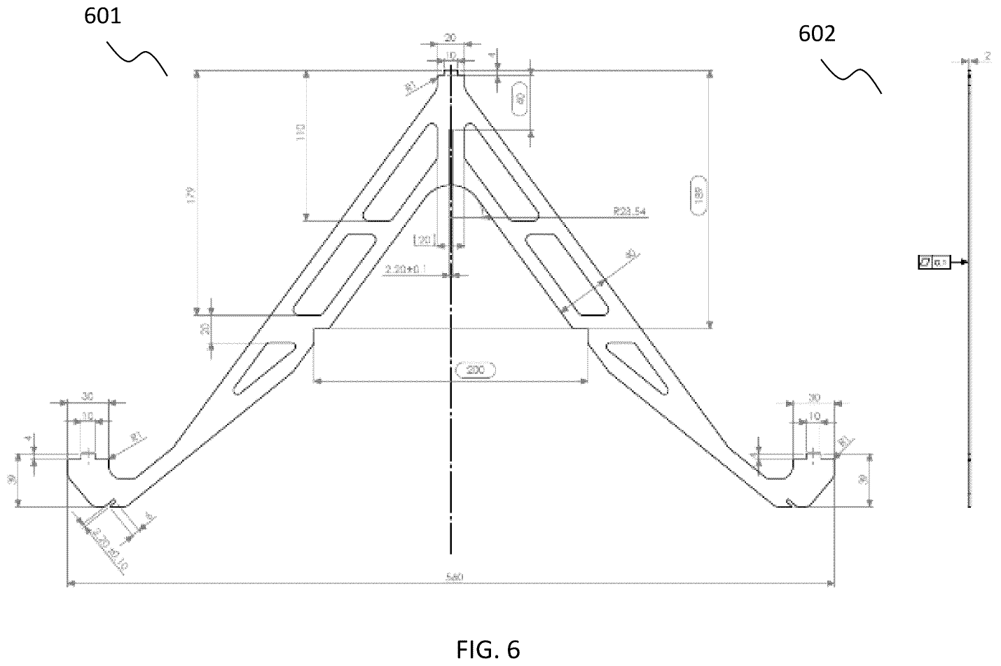

FIG. 6 depicts an illustrative first triangular support 401 in a front 601 and side 602 perspective in accordance with an embodiment. The dimensions are provided merely as an example. The dimensions may be varied according to the guidelines described herein.

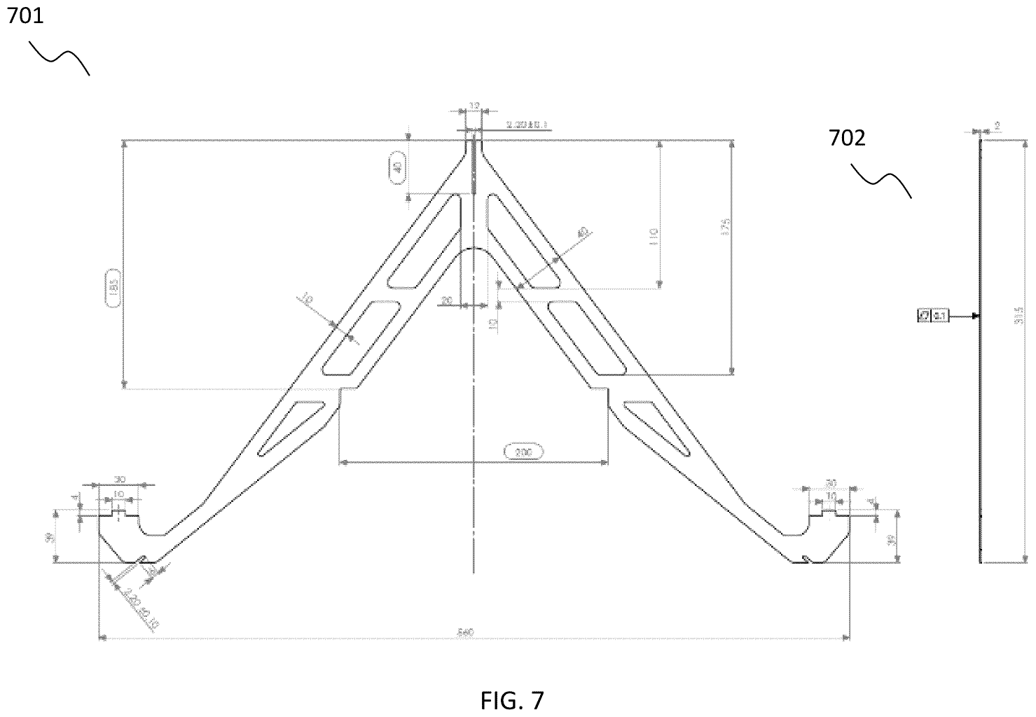

FIG. 7 depicts an illustrative second triangular support 402 in a front 701 and side 702 perspective in accordance with an embodiment. The dimensions are provided merely as an example. The dimensions may be varied according to the guidelines described herein.

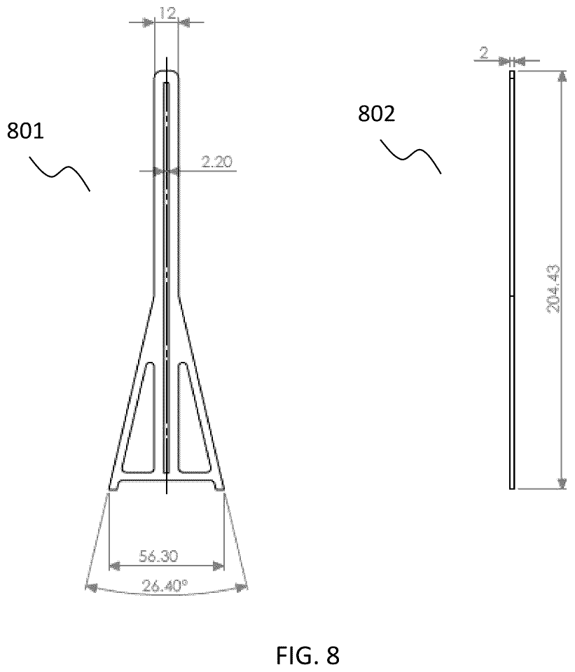

FIG. 8 depicts an illustrative distal support 404 in a front 801 and side 802 perspective in accordance with an embodiment. The dimensions are provided merely as an example. The dimensions may be varied according to the guidelines described herein.

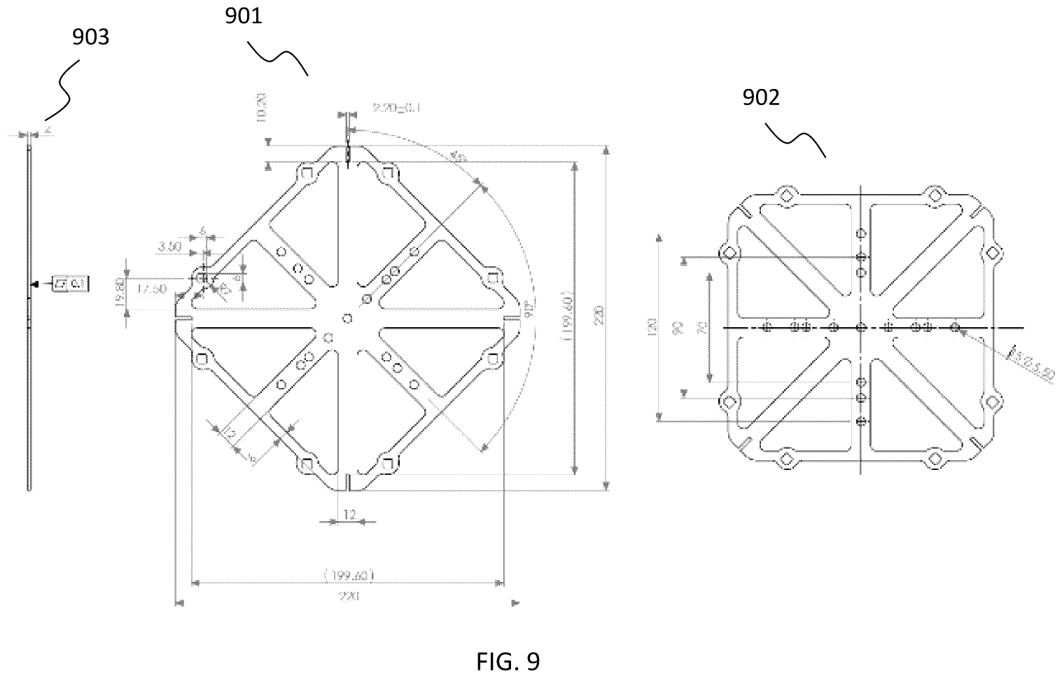

FIG. 9 depicts an illustrative base element 403 in a front 901, rotated 902, and side 903 perspective in accordance with an embodiment. The dimensions are provided merely as an example. The dimensions may be varied according to the guidelines described herein. The base element may include one or more mounting points for interfacing triangular supports 401, 402 and/or distal supports 404. The mounting points may accept any mounting element (e.g., pins, bolts, rivets, etc.).

In some embodiments, a process for enabling a faster and more accurate calibration of marker based optical tracking systems can include triggering a relative displacement of a rigid artifact to the tracker across the system's working volume.

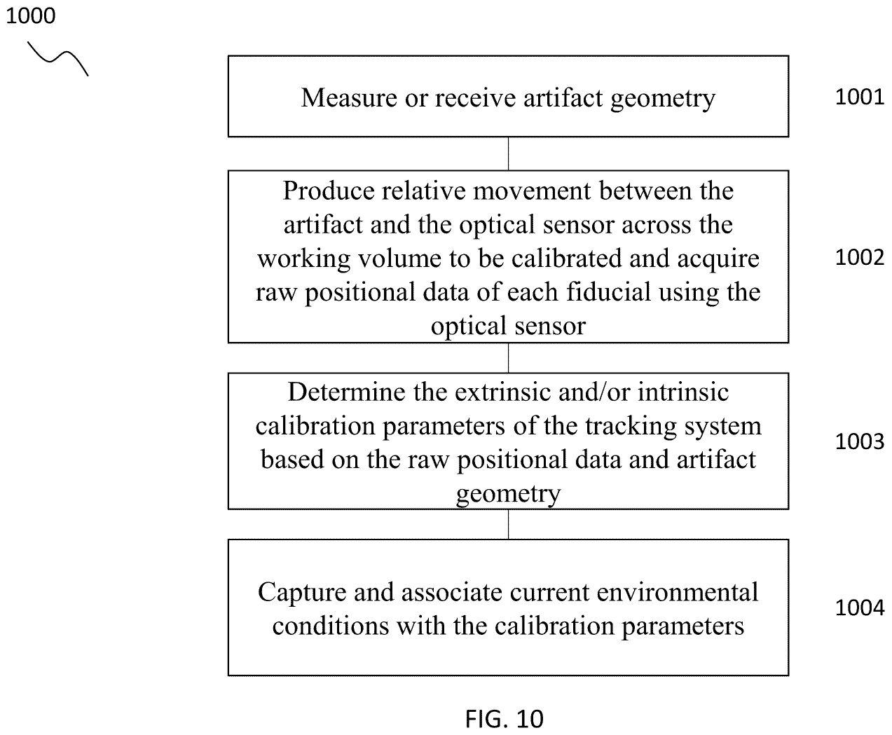

FIG. 10 illustrates a process 1000 for enabling the absolute calibration of an optical system in accordance with an embodiment. In some embodiments, an absolute calibration may be provided by a manufacturer. When determining the absolute calibration, the artifact geometry may be precisely known 1001, either through accurate manufacturing or precise measurement of the geometry of the fiducials.

The geometry of the virtual body including the fiducials can be measured on a CMM with a stylus, down to a positional accuracy of, for example, 0.03 mm (i.e., registration root-mean-square error). A reflective marker may aid in the measurement of the artifact 400 on the CMM because with other technologies, such as LEDs, the true localization of the light source may be more difficult to measure precisely. Other measurement tools (e.g., Light detection and ranging (LIDAR)) may alternatively be employed.

The artifact can be moved uniformly across the working volume to be calibrated Raw data of the positions of each fiducial marker on the optical sensor can be acquired 1002. Alternatively, the optical tracking system can move, and the artifact can be stationary, as long as the relative motion between the artifact and the optical system approximately covers the working volume to be calibrated.

An algorithm (e.g., bundle adjustment) can be used to evaluate the extrinsic and/or intrinsic parameters of the tracking system to calibrate it based on the raw positional data and the measured artifact geometry 1003. A bundle adjustment can minimize the reprojection error between the image locations of observed and predicted image points, which are expressed as the sum of squares of a large number of nonlinear, real-valued functions. Thus, the minimization may be achieved using nonlinear least-squares algorithms.

Environmental conditions (e.g., temperature and humidity) may also play a role in calibration. Measurements including the environmental conditions, the orientation of the optical tracking system, an internal temperature occurring during the process, and/or any other condition that affects the optical system calibration state, can be specified and attached to the calibration data 1004, so that the conditions of validity of the calibration can be retrieved. In some embodiments, the optical tracking system's internal temperature or external environmental temperature can be acquired simultaneously with the collection of raw positional data 1002. In some embodiments, the optical tracking system's internal humidity or external environmental humidity are acquired simultaneously with the collection of raw positional data 1002. In some embodiments, a gravitational vector or a local acceleration vector can be acquired simultaneously with the collection of raw positional data 1002. Sensors for the collection of environmental conditions can be implanted anywhere in the working environment including within the optical system or on the artifact.

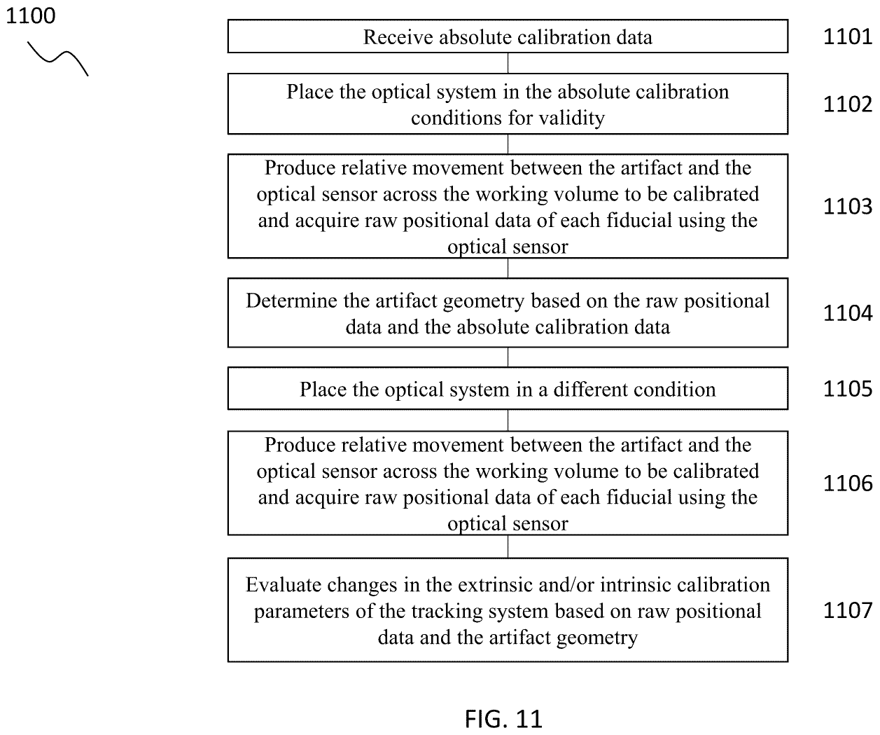

FIG. 11 depicts an illustrative process 1100 for enabling the relative calibration of an optical system in accordance with an embodiment. A relative calibration process 1100 may be performed when absolute calibration data, such as is described in reference to FIG. 10, is available. The artifact geometry may not be required to be precisely known. Instead, the optical tracking system should have absolute calibration data 1003 together with its conditions of validity 1004.

The optical system can be placed in the absolute calibration conditions of validity 1102. The artifact or calibration board can be moved uniformly across its calibrated working volume and the raw data of the positions of each fiducial on the optical sensor can be acquired 1103. Alternatively, the optical tracking system can move, and the artifact can be stationary, as long as the relative motion between the artifact and the optical system approximately covers the working volume to be calibrated. Based on the raw positional data and the absolute calibration data, the system can determine the artifact geometry 1104.

The optical system can be tested 1105 in a different condition. For example, the optical system can be tested 1105 in a different temperature or a different optical system tilting in the gravitational field. The artifact or calibration board can be moved uniformly across its calibrated working volume, and the raw data of the positions of each fiducial on the optical sensor can be acquired 1106. Alternatively, the optical tracking system can move, and the artifact can be stationary, as long as the relative motion between the artifact and the optical system approximately covers the working volume to be calibrated.

An algorithm (e.g., bundle adjustment) can be used to evaluate the extrinsic and/or intrinsic parameters of the tracking system to calibrate the tracking system based on the raw positional data and the derived artifact geometry 1107. The algorithm can determine the changes of the extrinsic and/or intrinsic parameters of the optical tracking system in the different conditions to be tested relative to the absolute calibration conditions.

The improved speed and accuracy of the proposed calibration process are the key elements that make the relative calibration process 1100 practical. For instance, a typical relative calibration process can determine the temperature compensation of an optical tracking system. The temperature can be controlled to vary steadily within a specified temperature use range of the tracking system. The process 1100 can be carried out iteratively while the temperature is changing. The shorter duration of the calibration process 1100 accommodates the practicality of an improved temperature resolution in optical system calibration measurements, as the calibration 1100 can be performed with a more constant temperature.

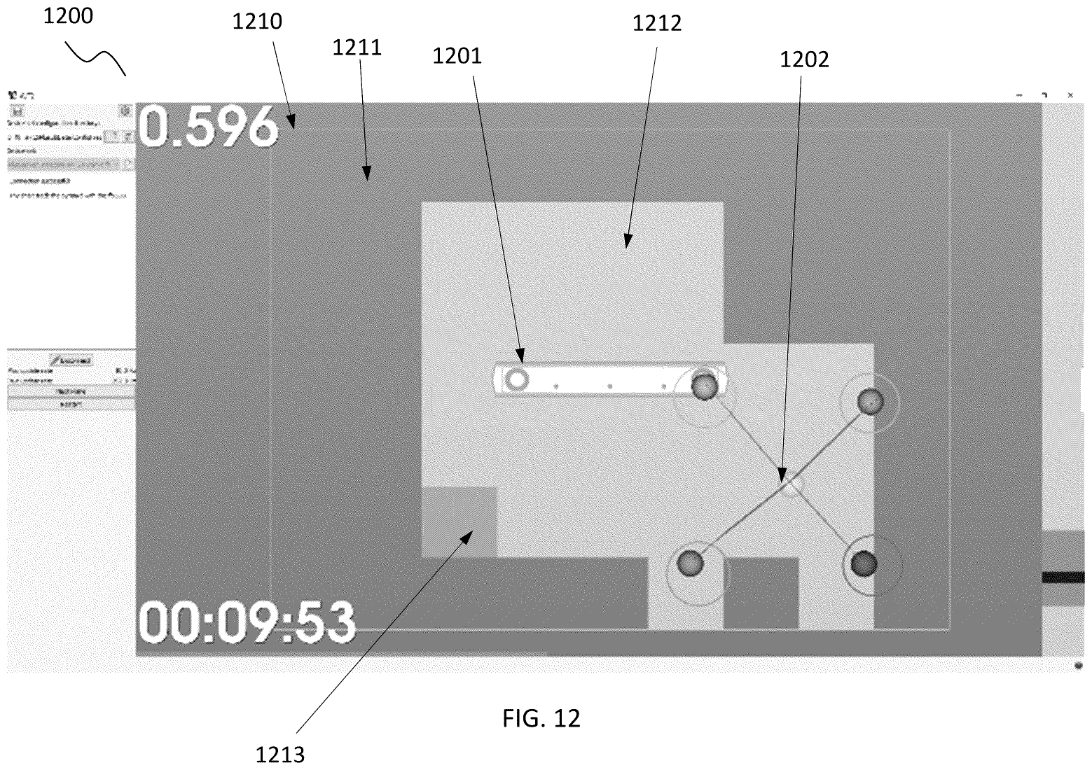

FIG. 12 depicts a graphical user interface (GUI) 1200 for guiding an operator toward an optimal (e.g., fast and uniform) path inside the working volume as they produce relative movement between the artifact and the optical sensor 1002, 1103, 1106. In this configuration, the GUI 1200 guides the operator to move the artifact in predefined regions that have an optimal coverage of the working volume 1210. The GUI 1200 can display relative positions of the optical sensor 1201 and the artifact 1202 with respect to the working volume 1210. The GUI 1200 may visually differentiate regions of the working volume 1210 that have been captured 1212, are uncaptured 1211, and/or are a suggested destination for the operator to continue the process 1213. The GUI 1200 can provide a further reduction of the duration of the calibration process, especially for less experienced operators.

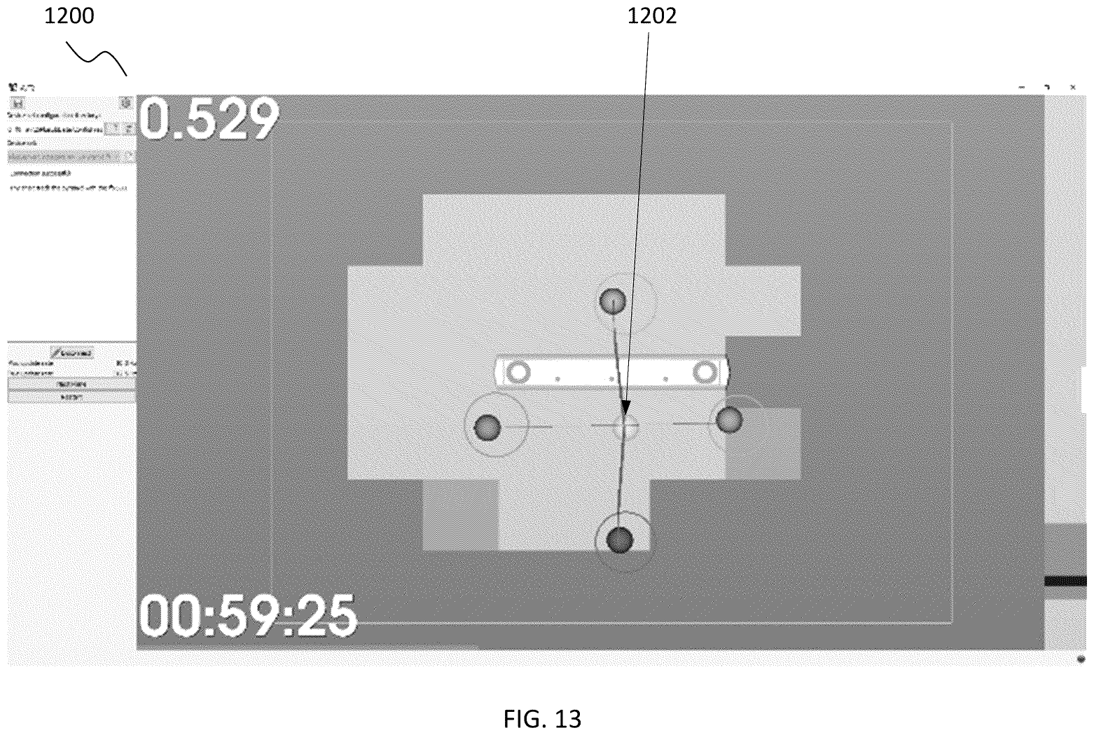

As illustrated in FIG. 13, the GUI 1200 can also be used to assess the accuracy of the optical tracking system (e.g., check the result of the calibration). In some embodiments, the artifact 1202 is rotated (e.g., by 45°) to ensure that different points from the ones used for the calibration process are used for the accuracy assessment. The calibration process 1000, 1100 can be repeated with the rotated artifact 1202 using the guidance described in reference to FIG. 12, and resulting calibration information can be compared to previous calibration information under the same conditions for validity.

In some embodiments, the artifact may not be manually moved by an operator through the working volume. For example, the artifact can be moved by a machine (e.g., a robot arm, a spider crane robot, a cartesian robot, a drone, or any wire-driven manipulator).

In some embodiments, the machine is navigated by an operator. For example, the operator can wear an Augmented Reality headset to facilitate a precise positioning of the artifact in space. In another example, the operator can use the GUI 1200 to operate the machine.

In some embodiments, the machine is navigated by an optical tracking system. The optical tracking system may be the system currently being calibrated. For example, a system can be configured to autonomously perform a recalibration. An autonomous recalibration may be completed automatically on a set schedule.

In some embodiments, the operator moves the artifact while wearing an Augmented Reality headset to facilitate a precise position of the artifact in space.

In some embodiments, the non-planar artifact can be used to co-register and/or recalibrate several tracking systems using bundle adjustment or similar techniques.

The calibration processes described herein may be applied to camera systems not designed for marker-based tracking. The process may be supplemented with an image segmentation algorithm able to recognize fiducials in an image.

Although the non-planar artifact described herein is pyramidal, other non-planar artifact geometries may also be used. For example, a cube, a tetrahedron or any other non-planar geometry satisfying the dimensional requirement described herein may be used.

In some embodiments, the non-planar artifact can be a hologram.

While various illustrative embodiments incorporating the principles of the present teachings have been disclosed, the present teachings are not limited to the disclosed embodiments. Instead, this application is intended to cover any variations, uses, or adaptations of the present teachings and use its general principles. Further, this application is intended to cover such departures from the present disclosure as come within known or customary practice in the art to which these teachings pertain.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various features. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

The term “about,” as used herein, refers to variations in a numerical quantity that can occur, for example, through measuring or handling procedures in the real world; through inadvertent error in these procedures; through differences in the manufacture, source, or purity of compositions or reagents; and the like. Typically, the term “about” as used herein means greater or lesser than the value or range of values stated by 1/10 of the stated values, e.g., +10%. The term “about” also refers to variations that would be recognized by one skilled in the art as being equivalent so long as such variations do not encompass known values practiced by the prior art. Each value or range of values preceded by the term “about” is also intended to encompass the embodiment of the stated absolute value or range of values. Whether or not modified by the term “about,” quantitative values recited in the present disclosure include equivalents to the recited values, e.g., variations in the numerical quantity of such values that can occur, but would be recognized to be equivalents by a person skilled in the art.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

The functions and process steps herein may be performed automatically or wholly or partially in response to user command. An activity (including a step) performed automatically is performed in response to one or more executable instructions or device operation without user direct initiation of the activity.

What is claimed:

1. A non-planar rigid device for calibrating an optical tracking system, the device comprising:
a pyramidal frame comprising:
two triangular supports, and
a base element; and
a plurality of markers, each comprising three or more retroreflective fiducials;
wherein the plurality of markers are interfaced vertices of the pyramidal frame.

2. The device of claim 1, wherein the pyramidal frame further comprises a plurality of distal supports, wherein each distal support interfaces the base element to a distal end of one of the two triangular supports.

3. The device of claim 1, wherein the base element is configured to be held by an operator.

4. The device of claim 1, wherein the base element is configured to be interfaced to a machine comprising at least one of: a robot arm, a spider crane robot, a cartesian robot, a drone, or a wire-driven manipulator.

5. The device of claim 1, wherein, for a smallest circumscribed rectangular parallelepiped, a maximal dimension length of the device is less than four times a minimal dimension length of the device.

6. The device of claim 1, wherein the device occupies at least one twentieth of a calibration working volume as determined from a perspective of the optical tracking system.

7. The device of claim 1, wherein the frame is made from 090 carbon epoxy laminate.

8. A method for providing a calibration for a marker-based optical tracking system, the method comprising:
providing a non-planar rigid artifact with a known geometry comprising a plurality of fiducials;
providing an optical sensor to be calibrated;
producing relative movement between the artifact and the optical sensor across a working volume;
acquiring raw positional data of each of the plurality of fiducials, using the optical sensor; and
determining calibration parameters of the optical tracking system based on the raw positional data and the artifact geometry.

9. The method of claim 8, further comprising capturing current environmental conditions and associating them with the calibration parameters.

10. The method of claim 8, further comprising measuring the artifact geometry with a coordinate measurement machine.

11. The method of claim 8, wherein the fiducials are retroreflective.

12. The method of claim 8, wherein the fiducials are LEDs.

13. The method of claim 8, wherein producing relative movement between the artifact and the optical sensor across a working volume comprises moving the artifact.

14. The method of claim 8, wherein producing relative movement between the artifact and the optical sensor across a working volume comprises moving the optical sensor.

15. The method of claim 9, wherein the environmental conditions comprise at least one of: an internal temperature of the optical sensor, an external temperature, an internal humidity of the optical sensor, an external humidity, an orientation, a gravitational vector, and a local acceleration vector of the optical sensor.

16. The method of claim 8, wherein producing relative movement between the artifact and the optical sensor across a working volume is performed by a machine comprising at least one of: a robot arm, a spider crane robot, a cartesian robot, a drone, or a wire-driven manipulator.

17. A method for providing a relative calibration an optical tracking system, the method comprising:
providing a non-planar rigid artifact comprising a plurality of fiducials;
providing an optical sensor to be calibrated;
receiving absolute calibration data for the optical tracking system comprising conditions for validity;
placing the optical tracking system in the conditions for validity;
producing relative movement between the artifact and the optical sensor across a working volume;
acquiring raw positional data of each of the plurality of fiducials, using the optical sensor;
determining an artifact geometry based on the raw positional data and the absolute calibration data;
placing the optical system in a different condition;
producing relative movement between the artifact and the optical sensor across the working volume;
acquiring raw positional data of each of the plurality of fiducials, using the optical sensor; and
determining relative calibration parameters of the optical tracking system based on the raw positional data and the artifact geometry for the different condition.

18. The method of claim 17, wherein producing relative movement between the artifact and the optical sensor across a working volume comprises moving the artifact.

19. The method of claim 17, wherein producing relative movement between the artifact and the optical sensor across a working volume comprises moving the optical sensor.

20. The method of claim 17, wherein the conditions for validity comprise at least one of: an internal temperature, an external temperature, an internal humidity, an external humidity, an orientation, a gravitational vector, and a local acceleration vector of the optical sensor.
